(19) United States
(12) Patent Application Publication
(10) Pub. No.: US 2015/0312111 A1
(43) Pub. Date: Oct. 29, 2015

(54) APPARATUS AND METHOD FOR DISTRIBUTING RULE OWNERSHIP AMONG DEVICES IN A SYSTEM

(71) Applicant: MOTOROLA SOLUTIONS, INC, SCHAUMBURG, IL (US)

(72) Inventors: ALEJANDRO G. BLANCO, FORT LAUDERDALE, FL (US); FABIO M. COSTA, WESTON, FL (US); MELANIE A. KING, HOLLYWOOD, FL (US); SHERVIN SABRIPOUR, PLANTATION, FL (US)

(73) Assignee: MOTOROLA SOLUTIONS, INC, SCHAUMBURG, IL (US)

(21) Appl. No.: 14/263,457

(22) Filed: Apr. 28, 2014

(51) Int. Cl. H04L 12/26; H04L 12/911

(52) U.S. Cl. CPC H04L 43/04; H04L 47/70

(57) ABSTRACT

A first device in a group of devices is assigned a role of operating as a server node for the group of devices. The server node determines that an entity is associated with one device in the group of communication devices. The server node creates a token and associates the token with the entity. The server node also identifies a resource type to which the entity belongs, assigns ownership for the token to one device based on the device being associated with the entity and further based on one or more of: at least one incident allocation criterion; at least one entity allocation criterion; and at least one node allocation criterion. One device executes at least one predefined entity rule associated with the resource type based on ownership of the token assigned to the entity.

### BACKGROUND OF THE INVENTION

An organization, for example, a public safety organization, may have different types of resources for responding to incidents or other events. Non-limiting examples of the resources may include users of communication devices, mobile communication devices such as mobile or portable radios, servers and other back end computing devices, and vehicles with communications systems. When an incident occurs, each resource having information related to the incident may transmit the information to other resources. Each resource may also execute local rules based on the information it receives from other resources or the information it transmits to other resources. Subsequent to executing the local rules, the resource may determine that certain conditions exist and/or that certain actions must be performed.

For example, consider that a police department has several mobile radios in an area. If a first mobile radio receives information indicating that a user associated with the first mobile radio is outside of a vehicle, that the user is running and that a shot has been fired, the first mobile radio may append a timestamp to the information prior to transmitting the information to other resources. The first mobile radio may also execute predefined local rules using the information it transmitted to other the resources and may determine, responsive to executing the local rules, for example, that a high threat level exists. If the rules associated with the determined high threat level also indicate, for example, that an alert of this threat level must be transmitted to other resources, the first mobile radio may also append a timestamp to the alert and transmit the alert in accordance with the rules. The first mobile radio may also perform other actions that are associated with the determined condition. For example, the first mobile radio may request a high priority network connection when such an action is associated with the high threat level.

Each of the resources receiving the information and/or alert from the first mobile radio may also execute predefined local rules and may also determine based on the received information that the condition (i.e., the high threat level) exists. Similar to the first mobile radio, each of the other resources receiving the alert from the first mobile radio may append a timestamp to its alert and send out the alert to other resources, including the first mobile radio. In other words, each resource executing the same rule may determine that the same condition exists and perform the same actions. This may lead to a circular situation wherein the resources may redundantly share the same known information with different timestamps with each other, thereby wasting the network bandwidth. Furthermore, when each resource receives information that is already known to the resource, the resource may reprocess the information (i.e., the resource may process newly received information even when that information was previously known and/or processed by the resource).

Accordingly, there is a need for an apparatus and method for distributing rule ownership among resources in a system so that a predefined resource may execute a predefined rule.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a network of nodes used in accordance with some embodiments.

FIG. 2 is a block diagram of a communication device used in accordance with some embodiments.

FIG. 3 illustrates a flow diagram of a method for assigning a token to an entity in accordance with some embodiments.

FIG. 4 illustrates a flow diagram of a method for assigning an incident entity token to an event in accordance with some embodiments.

FIG. 5 illustrates a flow diagram of a method for assigning an incident entity token to an incident entity in accordance with some embodiments.

FIG. 6 illustrates a flow diagram of a method for determining a new server node in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for method for distributed rule ownership. A first communication device in a group of communication devices is assigned a role of operating as a server node for the group of communication devices. The server node determines that an entity is associated with one of the first communication device and a second communication device in the group of communication devices. The server node creates a token and associates the token with the entity. The server node also identifies a resource type, that is, a type of entity such as a user entity or an incident entity, assigns ownership for the token to one of the first communication device and the second communication device based on one of the first communication device and the second communication device being associated with the entity and further based on one or more of: at least one incident allocation criterion; at least one entity allocation criterion; and at least one node allocation criterion. One of the first communication device and the second communication device executes at least one predefined entity rule associated with the resource type based on ownership of the token assigned to the entity.

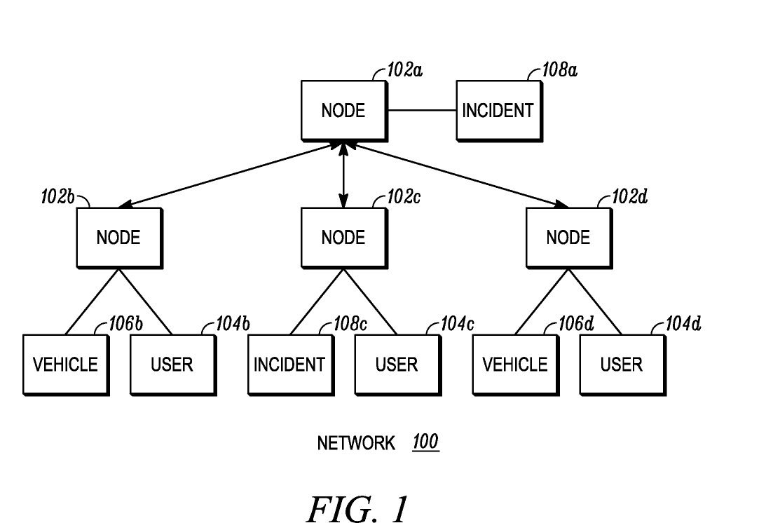

FIG. 1 is a block diagram of a network 100 of nodes used in accordance with some embodiments. Network 100 may include a group of nodes 102 (i.e., nodes 102a-102d), each of which is also referred to herein as a communication device 102. Each node 102 may be, for example, a communication device such as mobile or portable communication device or a computing device such as a back-end server or a laptop. Each node 102 may be communicatively coupled to at least one other node in network 100 and each node 102 may be configured to execute one or more sets of rules based on information transmitted and/or received by that node. The topology of network 100 may be dynamic, i.e., the network topology may change depending on how nodes 102 are connected to each other. Non-limiting examples of the network topologies that may be formed by nodes 102 may include an ad-hoc network topology, a meshed network topology, and a star network topology.

One node, for example, node 102a, may be assigned to role of a server node. Node 102a may be preconfigured to operate as the server node or node 102a may be dynamically selected by the other nodes 102 (i.e., one or more of nodes 102b-102d) to operate as the server node. The server node identifies groups of resources in network 100 and assigns a token to each resource in each resource group or type. For example, one resource group or type may comprise a physical entity, such as a user entity or a vehicular entity, and another resource group or type may comprise an event entity, such as an emergency event or incident. A physical entity may be, for example, a user or a vehicle that is associated with a specific node 102. An event entity may be, for example, an incident that may or may not be associated with a specific node 102. Both the physical entity and the event entity are generally referred to herein as an entity.

When a node, such as nodes 102b, 102c, or 102d, connects to network 100, the server node, that is, node 102a, may determine one or more entities, such as a physical entity and/or an event entity, that are currently associated with the node and may assign a token to each such entity associated with the node. For example, when node 102b connects to network 100, server node 102a may determine that a first and a second physical entity, such as a user 104b and a vehicle 106b, are associated with node 102b and may assign a token to each of user 104b and vehicle 106b. Similarly, when node 102c connects to network 100, server node 102a may determine that a third physical entity and a first event entity, that is, a user 104c and an incident 108c, are each associated with node 102c and the server node may assign a token to each of user 104c and incident 108c. And when node 102d connects to network 100, server node 102a may determine that a fourth and a fifth physical entity, that is, a user 104d and a vehicle 106d, are each associated with node 102d and the server node may assign a token to each of user 104d and vehicle 106d. Again, resource groups/types as used herein may comprise, among other resource types, physical entities, such as users and vehicles, or event entities, such as emergency incidents.

In some embodiments, server node 102a may determine that a new entity, such as a physical entity or an event entity, has been added to network 100 based on information received from a non-server node associated with the new entity. Accordingly, subsequent to determining that a new entity has been added to network 100, server node 102a may create a token for that entity, wherein server node 102a may create a token for each physical entity or event entity added to network 100.

Consider, for example, that server node 102a is associated with incident 108a, node 102b is associated with user 104b and vehicle 106b, node 102c is associated with user 104c and incident 108c, and node 102d is associated user 104d and vehicle 106d, as shown in FIG. 1. Subsequent to being assigned the role of a server node, node 102a may create a first type entity token, such as user token (for example, user tokens UT-1, UT-2 and UT-3) for each of first type of physical entity (i.e., users 104b, 104c and 104d) and may assign a user token to each such user, for example, UT-1 to user 104b, UT-2 to user 104c, and UT-3 to user 104d. Similarly, server node 102a may also create a second type entity toke, that is, an event or incident token (for example, incident tokens IT-1 and IT-2) for each of the event, or incident, entities (i.e., incidents 108a and 108c) and may assign an event/incident token to each event/incident entity, for example, incident token IT-1 to incident 108a and incident token IT-1 to incident 108c. And server node 102a may create a third type entity token, such as vehicle tokens (for example, vehicle tokens VT-1 and VT-2) for each of a second type of physical entity (i.e., vehicles 106b and 106d), and may assign a vehicle token to each vehicle entity, for example, vehicle token VT-1 to vehicle 106b and vehicle token VT-2 to vehicle 106d).

Subsequent to assigning a token to each physical entity (e.g., user entity or vehicle entity) or event entity (e.g., an incident entity), server node 102a may assign ownership for the token to the node associated with the physical entity or event entity assigned the token. Accordingly, in FIG. 1, server node 102a may assign ownership for the token associated with incident 108a to itself. Server node 102a may also assign ownership for the tokens associated with user 104b and vehicle 106b to node 102b, server node 102a may assign ownership for the tokens associated with user 104c and incident 108c to node 102c, and server node 102a may assign ownership for the tokens associated with user node 104d and vehicle 106d to node 106d. Each owner node (i.e., each node with ownership of a token) may execute at least one set of predefined entity rules that are associated with the resource type for the entity associated with the token. For example, each of nodes 102b, 102c and 102d may execute at least one set of predefined entity rules that are associated with a first resource group or type, for example, a first type of physical entity such as a user n(or user entity), each of nodes 102b and 102d may execute at least one set of predefined entity rules that are associated with a second resource group or type, for example, a second type of physical entity such as a vehicle (or vehicle entity), and each of nodes 102a and 102c may execute at least one set of predefined entity rules that are associated with a third resource group or type, for example, an event entity such as an incident (or incident entity).

For example, if vehicle 106b becomes disconnected from its associated node 102b, server node 102a may mark the token (e.g., a vehicle token) associated with vehicle 106b for reallocation. At a subsequent time, if vehicle 106b becomes reconnected to network 100 via a different node, that is, node 102c, server node 102a may reassign the token to vehicle 106b and assign ownership for the reassigned token to node 102c, or server node 102a may assign a new token to vehicle 106b and assign ownership for the new token to node 102c.

When server node 102a loses contact with a non-server node (for example, node 102b), server node 102a may de-allocate tokens assigned to non-server node 102b, remove the entity types associated with node 102b, and re-allocate the tokens previously assigned to node 102b to another node, if necessary. If node 102b loses contact with server node 102a, node 102b may wait for a predefined-time period (referred to herein as a hysteresis time) and may check to see if it can reconnect with server node 102a within the hysteresis time. If node 102b cannot not reconnect with server node 102a within the hysteresis time, node 102b may establish connections with a new server node.

Each of nodes 102 then may use the tokens assigned to each entity or resource type associated with the node to determine how to share data. For example, if specific information is needed to execute a rule associated with a user entity or resource type, the tokens assigned to user entities may be used to manage data flow. Therefore, each of nodes 102b, 102c and 102d, by use of the tokens assigned to user entities associated with the node and which tokens are, in turn, owned by the node, may receive the specific information needed to execute the rule(s) associated with the user entity or resource type. In some embodiments, information that is required to execute a rule associated with a resource type may be tagged with (appended to) the tokens assigned to the resource type. Nodes 102 may use the tag(s) during, for example, transmission of information.

An event entity may have a geographical boundary (referred to herein as a geo-fence) and/or a time interval (referred to herein as a time-window). At the time server node 102a determines that an event entity is present in network 100, the event entity may or may not be associated with a specific node. For example, when an event entity, such as an environmental event such as a toxic chemical detection, occurs within a given location, subsequent to processing information associated with the environmental event, server node 102a may determine that the event entity (the environmental event) is not, at that time, associated with a specific node. Server node 102a then may determine to associate the event entity with a selected node based on a predefined criterion.

A new node may become the server node when connectivity between nodes 102 changes. For example, if node 102a is no longer communicatively coupled to nodes 102a, 102c and/or 102d, then a new node may become the server node. Also, if a new server node (not shown) is added to network 100, then the new server node may take over from node 102a and become the server node. Each time a new server node is assigned to operate as the server node, each non-server nodes may report its current token assignment(s) to the new server node, may release its current token assignments, and may discontinue executing rules associated with the current token assignments. The new server may subsequently reassign tokens to the non-server nodes and inform the non-server nodes of the subsequently reassigned tokens.

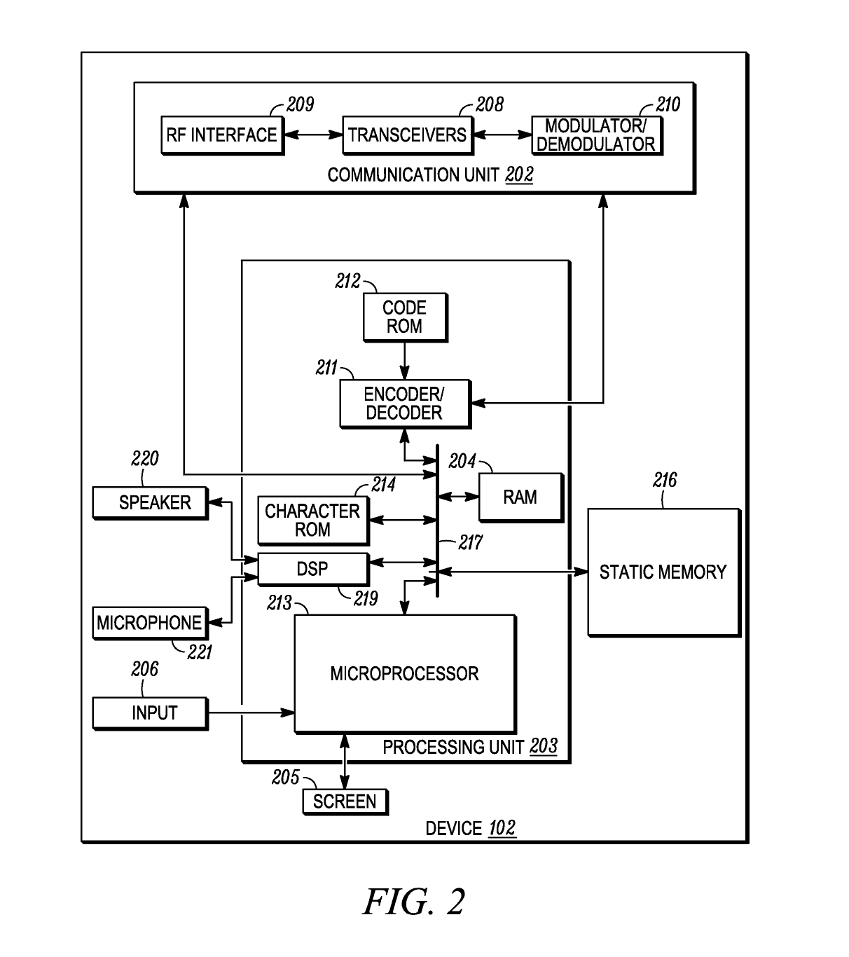

FIG. 2 is a block diagram of a communication device 102 used in accordance with some embodiments. Communication device 102 may be, for example, a radio that includes a communications unit 202 coupled to a common data and address bus 217 of a processing unit 203. Communication device 102 may also include an input unit (e.g., keypad, pointing device, etc.) 206, an output transducer unit (e.g., speaker) 220, an input transducer unit (e.g., a microphone) (MIC) 221, and a display screen 205, each coupled to be in communication with the processing unit 203.

Processing unit 203 may include an encoder/decoder 211 with an associated code read-only memory (ROM) 212 for storing data for encoding and decoding voice, data, control, or other signals that may be transmitted or received by communication device 102. Processing unit 203 may further include a microprocessor 213 coupled, by the common data and address bus 217, to the encoder/decoder 211, a character ROM 214, a random access memory (RAM) 204, and a static memory 216. One or more of ROM 214, RAM 204 and static memory 216 may include a non-volatile memory portion for storing the timestamp and counter values of communication device 200. The processing unit 203 may also include a digital signal processor (DSP) 219, coupled to the speaker 220, the microphone 221, and the common data and address bus 217, for operating on audio signals received from one or more of the communications unit 202, the static memory 216, and the microphone 221. Unless otherwise specified herein, the operations described as being performed by communication device 102 herein is performed by processing unit 203, and more particularly by one or more of microprocessor 213 and DSP 219.

Communications unit 202 may include an RF interface 209 configurable to communicate with network components, and other user equipment within its communication range. Communications unit 202 may include one or more broadband and/or narrowband transceivers 208, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 202 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 210 that is coupled to the encoder/decoder 211.

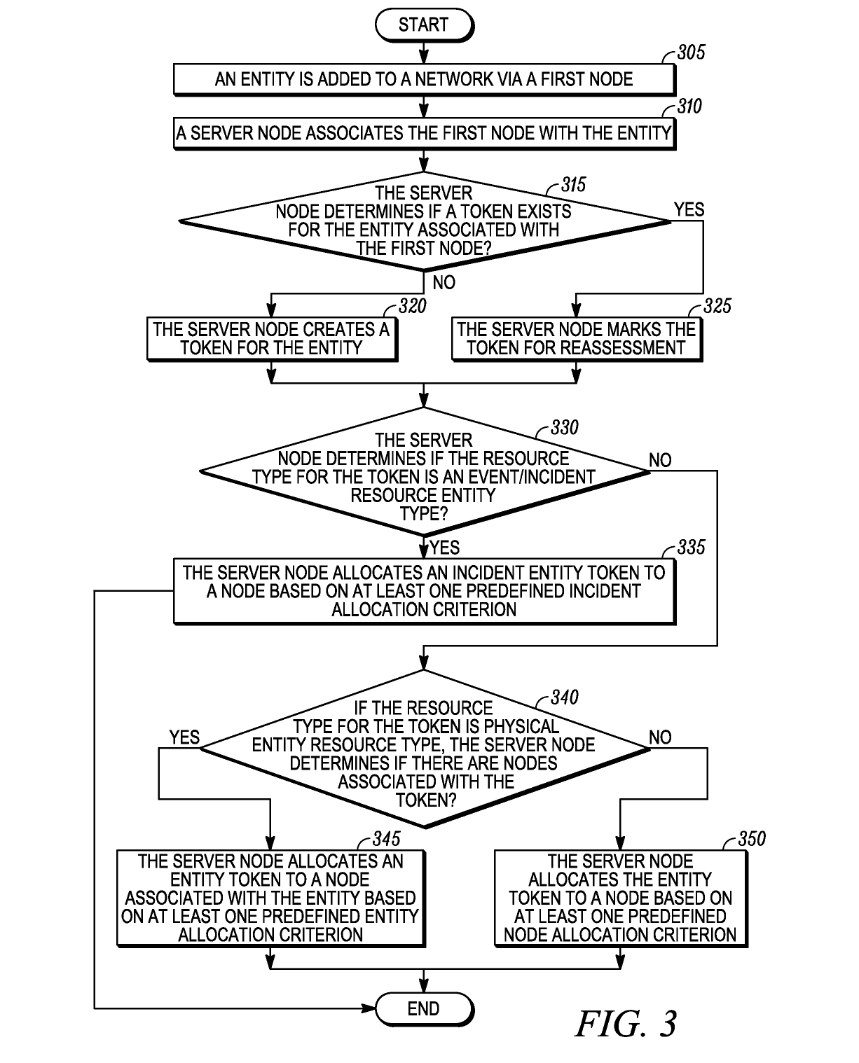

The character ROM 214 stores code for decoding or encoding data such as control, request, or instruction messages, channel change messages, and/or data or voice messages that may be transmitted or received by communication device 200. Static memory 216 may store operating code for performing one or more of the steps set forth in FIGS. 3-6.

FIG. 3 illustrates a flow diagram of a method for assigning a token to an entity in accordance with some embodiments. At 305, an entity is added to a network via a first node. The entity may be, for example, a physical entity such as a user that connects to the network using the first node or an event entity that is associated with the first node. At 310, a server node associates the first node with the entity. At 315, the server node determines if a token exists for the entity associated with the first node. At 320, if no token exists, the server creates a token for the entity. At 325, if a token exists, the server node marks the token for reassessment.

At 330, for each newly created token or for each token marked for assessment, the server node determines whether the resource type or group, associated with the token is a physical resource type or group (associated with physical entities) or an event resource type or group (associated with event entities). If the resource type or group associated with the token is an event resource type or group, then at 335 the server node allocates an event token to a node based on at least one predefined incident allocation criterion. Non-limiting examples of the predefined incident allocation criterion may include assigning the incident entity token to an available server, assigning the incident entity token to a node nearest to an incident location, assigning the incident entity token to a node associated with or near an incident commander, assigning the incident entity token to a node with the lowest number of assigned tokens, and assigning the incident entity token to a node that is not battery powered. The flow diagram then ends.

If the resource type or group associated with the token is a physical resource type or group, then at 340 the server node determines if there is a node associated with the token. If there is a node associated with the token, then at 345 the server node allocates an entity token to the node associated with the physical resource type or group, based on at least one predefined entity allocation criterion. Non-limiting examples of the predefined entity allocation criterion may include assigning the entity token to a node with the lowest number of assigned tokens, assigning the entity token to the most actively used node, and assigning the entity token to a node that is not battery powered. If there is not a node associated with the token, then at 350 the server node allocates the entity token to a node that is selected by the server node based on at least one predefined node allocation criterion and the flow diagram then ends. Non-limiting examples of the predefined node allocation criterion may include assigning the entity token to a node with the lowest number of assigned tokens, assigning the entity token associated with an incident to a node associated with the incident, and assigning the entity token to a node that is not battery powered.

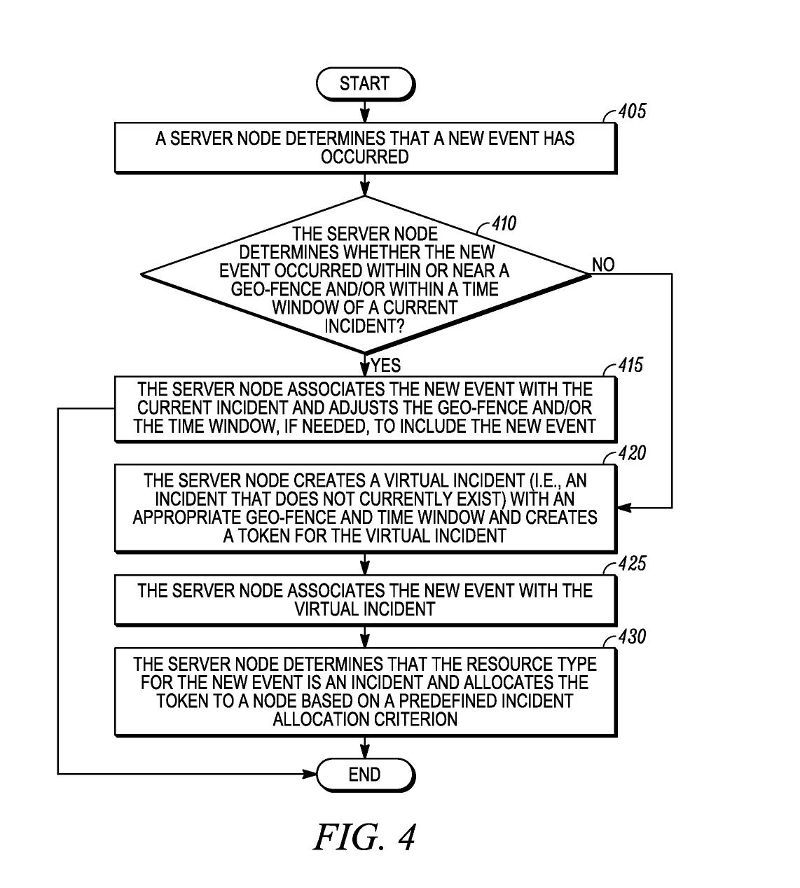

FIG. 4 illustrates a flow diagram of a method for assigning an event entity token to an event in accordance with some embodiments. At 405, a server node determines that a new event entity has occurred. The event may be, for example, an incident such as an environmental event. The new event entity/incident may be determined by the server node or the new event entity/incident may be determined by another node and reported to the server node. At 410, the server node determines whether the new event entity/incident occurred within or near a geo-fence and/or within a time window of a current event entity or incident. If the new event entity/incident occurred within or near a geo-fence and/or within a time window of a current event entity/incident, then at 415, the server node associates the new event entity/incident with the current event entity/incident and adjusts the geo-fence and/or the time window, if needed, to include the new event entity/incident. The flow diagram then ends.

If the new event entity/incident does not occur within or near a geo-fence and/or within a time window of a current event entity/incident, then at 420, the server node creates a virtual event entity/incident (i.e., a fictitious event or incident that does not currently exist) with an appropriate geo-fence and time window and creates a token for the virtual event entity/incident. At 425, the server node associates the new event entity/incident with the virtual event entity/incident. At 430, the server node determines that the resource type of the new event entity/incident is an event, or incident, resource type and allocates the token to a node based on a predefined event, or incident, allocation criterion. The flow diagram then ends.

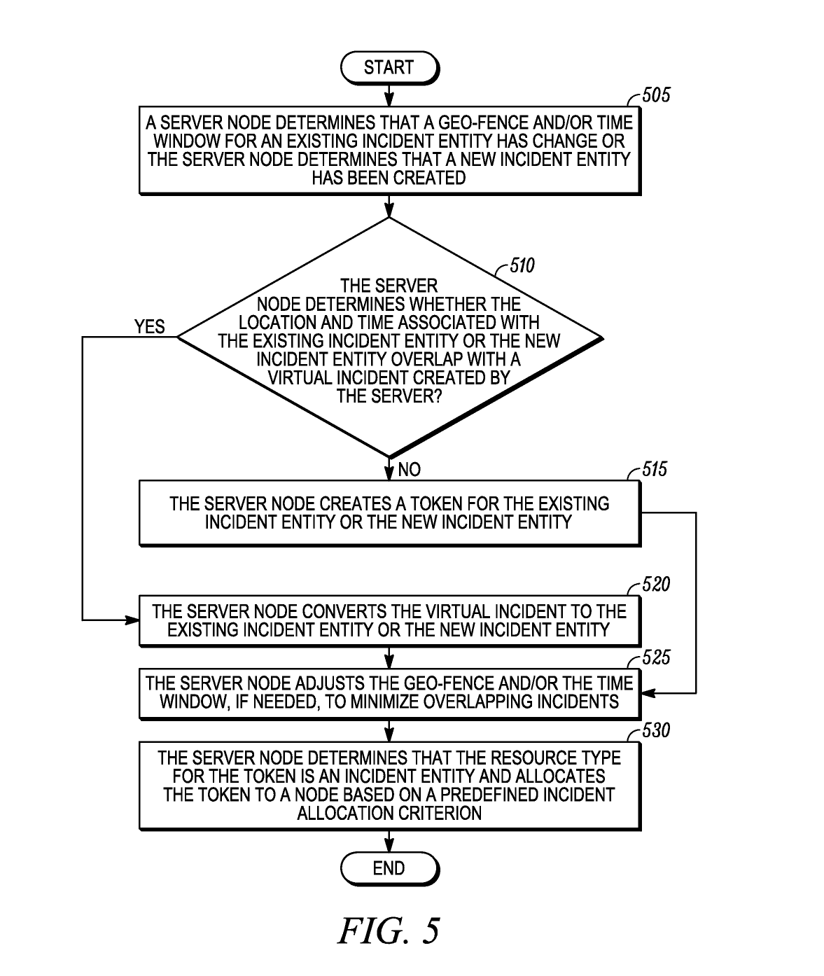

FIG. 5 illustrates a flow diagram of a method for assigning an event entity token to an event entity/incident in accordance with some embodiments. At 505, a server node determines that a geo-fence and/or time window for an existing event entity/incident has changed, or the server node determines that a new event entity/incident has been created. At 510, the server node determines whether a location and time associated with the existing event entity/incident or the new event entity/incident overlaps with a virtual event entity/incident already created by the server node. If the location and time associated with the existing event entity/incident, or the new event entity/incident, does not overlap with a virtual event entity/incident, then at 515 the server node creates a token for the existing or new event entity/incident. If the location and time associated with the existing event entity/incident or new event entity/incident overlaps with a virtual event entity/incident, then at 520 the server node converts the virtual event entity/incident to the existing or new event entity/incident. At 525, the server node adjusts the geo-fence and/or the time window, if needed, to minimize overlapping event entities/incidents. At 530, the server node determines that the resource type for the token is an event entity/incident and allocates the token to a node based on a predefined event, or incident, allocation criterion. The flow diagram then ends.

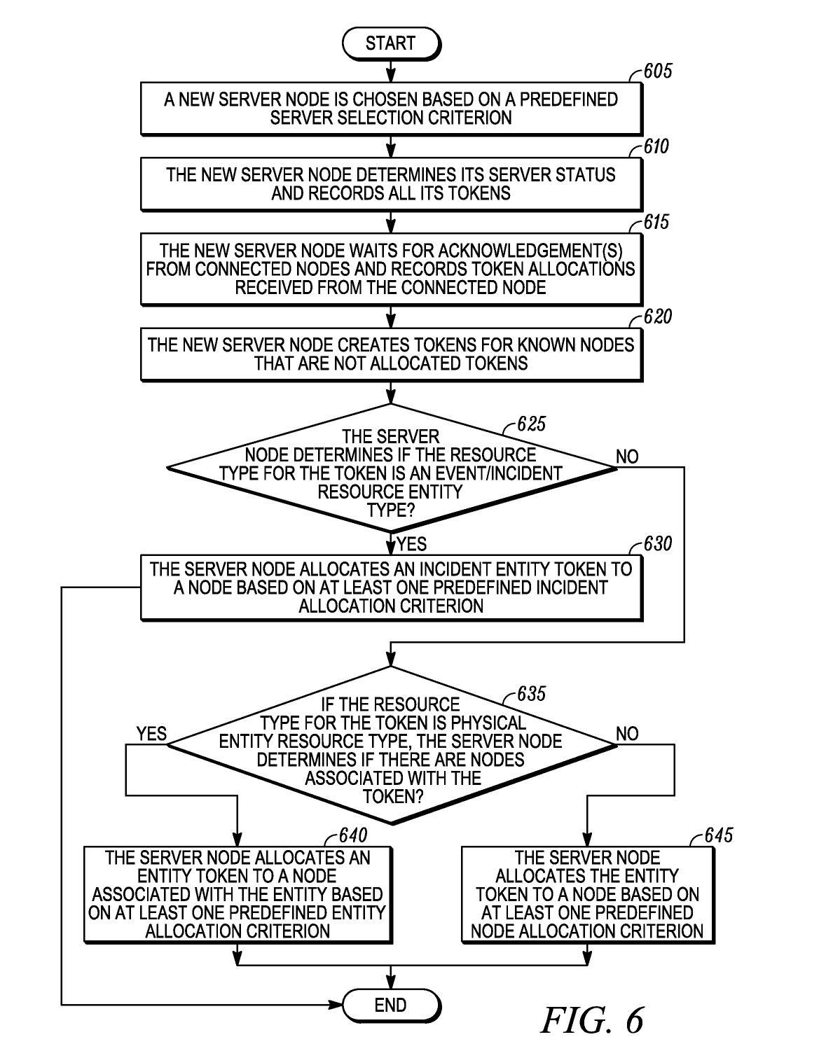

FIG. 6 illustrates a flow diagram of a method for determining a new server node in accordance with some embodiments. At 605, a new server node is chosen based on a predefined server selection criterion. Non-limiting examples of the predefined server selection criterion may include selecting the new server node based on its broadcasting range, based on its proximity to an incident location, based on the number of nodes communicatively coupled to the new server node, based on its proximity to or association with an incident commander, based on whether or not the new server node is battery powered, and based on whether the new server node is identified as a server class node.

At 610, the new server node determines its server status and records all its tokens. At 615, the new server node waits for acknowledgement(s) from connected nodes and receives from the connected nodes, and records, information concerning tokens allocated to the connected nodes. At 620, the new server node creates tokens for known nodes that are not allocated tokens. At 625, for each newly created token, the server node determines if the resource type for the token is an event resource type (i.e., the token type is an event, or incident, token). If the resource type for the token is an event resource type, then at 630 the server node allocates the token to a node based on at least one predefined event/incident allocation criterion and the flow diagram ends. If the resource type for the token is not an event resource type, then at 635 the server node determines if there is an entity associated with the token. If there is an entity associated with the token, then at 640 the server node allocates the token to a node associated with the entity based on at least one predefined entity allocation criterion. If there is not an entity associated with the token, then tt 645, the server node allocates the token to a node based on at least one predefined node allocation criterion.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for distributed rule ownership comprising:
assigning, to a first communication device in a group of communication devices, a role of operating as a server node for the group of communication devices;
determining, by the server node, that an entity is associated with one of the first communication device and a second communication device in the group of communication devices;
creating, by the server node, a token and associating the token with the entity;
identifying, by the server node, a resource type to which the entity belongs;
assigning ownership, by the server node, for the token to one of the first communication device and the second communication device based on one of the first communication device and the second communication device being associated with the entity and further based on one or more of:
at least one incident allocation criterion;
at least one entity allocation criterion;
at least one node allocation criterion; and
executing, by one of the first communication device and the second communication device and based on ownership of the token assigned to the entity, at least one predefined entity rule associated with the resource type.

2. The method of claim 1, wherein the entity is one of a physical entity and an event entity.

3. The method of claim 1, wherein the associating the token with the entity comprises determining that the token is associated with the entity and marking the token for reassessment.

4. The method of claim 1, wherein when the entity is disconnected from the second communication device and is associated with a third communication device, the token associated with the entity is marked for reallocation and ownership of the token is assigned to the third communication device.

5. The method of claim 1, further comprising determining, by a third communication device in the group of communication devices, that the first communication device is communicatively uncoupled from the group of communication devices and operating, by the third communication device, as the server node for the group of devices.

6. The method of claim 5, further comprising reporting, by each communication device in the group of communication device, token assignments to the third device;
deleting, by each communication device assigned a token in the group of communication devices, token assignments provided by the first communication device;
discontinuing, by each communication device in the group of communication devices, execution of rules associated with deleted token assignments.

7. The method of claim 1, further comprising using the token, by each communication device assigned a token in the group of communication devices, to determine how data is to be shared with the group of devices.

8. The method of claim 1, wherein assigning ownership comprises assigning ownership based on at least one incident allocation criterion and wherein the incident allocation criterion comprises at least one of assigning an incident token to an available server, assigning the incident token to a device nearest to an incident location, assigning the incident token to a device associated with or near an incident commander, assigning the incident token to a device with the lowest number of assigned tokens, and assigning the incident token to a device that is not battery powered.

9. The method of claim 1, wherein assigning ownership comprises assigning ownership based on at least one entity allocation criterion and wherein the entity allocation criterion comprises at least one of assigning an entity token to a communication device with the lowest number of assigned tokens, assigning the entity token to the most actively used communication device, and assigning the entity token to a communication device that is not battery powered.

10. The method of claim 1, wherein assigning ownership comprises assigning ownership based on at least one node allocation criterion and wherein the node allocation criterion comprises at least one of assigning an entity token to a communication device with the lowest number of assigned tokens, assigning the entity token associated with an incident to a communication device associated with the incident, and assigning the entity token to a communication device that is not battery powered.

11. The method of claim 1, wherein when the server node loses connection with the second communication device, the server node deallocates the token assigned to the second communication device.

12. The method of claim 1, wherein when the second communication device loses connection with the server node, the second communication device determines if it can reconnect with the server node within a hysteresis time, wherein if the second communication device cannot reconnect with the server node within the hysteresis time, the second communication device connects to a new server node.

13. An apparatus, comprising:
a first communication device that operates as a server node in a group of communication devices, wherein the communication device comprises:
a processing unit that is configured to:
determine that an entity is associated with one of the first communication device and a second communication device in the group of communication devices;
create a token and associate the token with the entity;
identify, an resource type to which the entity belongs;
assign ownership, by the communication device, for the token to one of the first communication device and the second communication device based on one of the first communication device and the second communication device being associated with the entity and further based on one or more of:
at least one incident allocation criterion;
at least one entity allocation criterion;
at least one node allocation criterion; and
wherein one of the first communication device and the second communication device is configured to execute, based on the ownership of the token, at least one predefined entity rule associated with the resource type.

14. The apparatus of claim 13, wherein subsequent to the first communication device being communicatively uncoupled from the group of communication devices, a third communication device in the group becomes a server node for the group of communication devices.

15. The apparatus of claim 14, wherein subsequent to the third communication device becoming the server node, each non-server communication device in the group of communication devices is configured to:
report token assignments to the third communication device;
delete token assignments provided by the first communication device;
discontinue execution of rules associated with deleted token assignments.

16. The apparatus of claim 14, wherein subsequent to the third communication device becoming the server node, the third communication device is configured to:
record tokens assigned to the third communication device and tokens allocated to non-server communication devices in the group;
create a token for an unassigned entity connected to the one communication device when the token is not previously assigned to the unassigned entity;
identify the resource type to which the unassigned entity belongs; and
assign ownership for the token to a communication device associated with the unassigned entity, based on one or more of:
at least one incident allocation criterion;
at least one entity allocation criterion; and
at least one node allocation criterion.

17. A method, comprising:
determining, by a first communication device in a group of communication devices, that the first communication device is a server node for the group of communication devices;
determining, by the server node, that a new event has occurred;
determining, by the server node, that a current incident exists at least one of near a geographical boundary of the new event and within a time window of the new event;
responsive to determining that the current incident exists at least one of near the geographical boundary of the new event and within the time window of the new event, associating, by the server node, the new event with the current incident;
responsive to determining that no current incident exists at least one of near the geographical boundary of the new event and within the time window of the new event, the server node is configured to:
create a virtual incident and assign the geographical boundary and the time window of the new event to the virtual incident;
associate a token with the virtual incident;
identify a resource type to which the virtual incident belongs; and
assign ownership for the token to one communication device based on at least one incident allocation criterion;
wherein each communication device in the group of communication devices is configured to execute at least one predefined entity rule associated with the resource type based on ownership of an associated token.

18. The method of claim 17, wherein associating the new event with the current incident comprises adjusting at least one of the geographical boundary and the time window of the current incident.

19. The method of claim 17, wherein the determining that the new event has occurred comprises determining that one of a modification to the current incident has occurred and a new incident is created;
determining that the geographical boundary and the time window of one of the current incident and the new incident overlaps with the geographical boundary and the time window of the virtual incident and converting the virtual incident to one of the existing incident and the new incident;
determining that no overlap exists between the geographical boundary and the time window of one of the current incident and the new incident and the geographical boundary and the time window of the virtual incident, creating a second token and associating the second token with one of the existing incident and the new incident; and
adjusting the geographical boundary and the time window of one of the existing incident and the new incident.
